(19) United States
(12) Patent Application Publication
(10) Pub. No.: US 2026/0319349 A1
(43) Pub. Date: Oct. 15, 2026

(54) DISPLAY DEVICE AND DISPLAY METHOD

(71) Applicant: SONY GROUP CORPORATION, Tokyo (JP)

(72) Inventors: Takatoshi NAKAMURA, Tokyo (JP); Kuniaki KURIHARA, Tokyo (JP)

(73) Assignee: SONY GROUP CORPORATION, Tokyo (JP)

(21) Appl. No.: 19/481,133

(22) PCT Filed: May 21, 2024
(86) PCT No.: PCT/JP2024/018633

§ 371 Date: Nov. 3, 2025

(30) Foreign Application Priority Data
Jun. 1, 2023 (JP) 2023-090873

(51) Int. Cl. G03B 21/20; H04N 5/74

(52) U.S. Cl. CPC G03B 21/204; H04N 5/74

(57) ABSTRACT

A display device according to the present technology includes a display unit on which a plurality of phosphors is two-dimensionally arrayed on a base material, and a light irradiation unit that two-dimensionally scans and irradiates a display surface that is a surface of the display unit on which the phosphors are arrayed with light.

### TECHNICAL FIELD The present technology relates to a display device and a display method, and particularly relates to a technology for displaying an image by causing a phosphor to emit light.

### BACKGROUND ART

For example, a projector device is known as a display device for performing image display on a relatively large screen such as image display in a movie theater, and as an example, an RGB laser projector that realizes image display by irradiating a screen having a diffuse reflection surface with laser beams of red (R), green (G), and blue (B) is known.

The RGB laser projector has an advantage that focusing is unnecessary since the screen is irradiated with a collimated laser beam, but has a disadvantage that spot-shaped noise called speckle noise is likely to occur due to the property of reflecting the laser beam on the diffuse reflection surface.

Here, Patent Document 1 below can be cited as involved related art. Patent Document 1 discloses a technology for realizing display of a color image by including three types of light sources having different wavelengths and a spatial light modulator for every light source and projecting a projected representation having each wavelength generated by the spatial light modulator onto a screen coated with a mixture of R, G, and B fluorescent materials in a time division manner.

In the technology described in Patent Document 1, since image display is realized by causing a phosphor to emit light, generation of speckle noise can be prevented.

### CITATION LIST

### Patent Document

Patent Document 1: Japanese Patent Application Laid-Open No. 2003-330104

### SUMMARY OF THE INVENTION

### Problems to be Solved by the Invention

However, in the technology described in Patent Document 1 described above, it is necessary to use a plurality of light sources having different wavelengths in image display, and it is necessary to provide a spatial light modulator for generating a projected representation for every light source (every wavelength). As a result, a configuration of a display device becomes complicated, and device manufacturing cost tends to increase with an increase in the number of components.

The present technology has been made in view of the circumstances described above, and an object thereof is to reduce device manufacturing cost by reducing the number of components of a display device while preventing generation of speckle noise.

### Solutions to Problems

A display device according to the present technology includes a display unit on which a plurality of phosphors is two-dimensionally arrayed on a base material, and a light irradiation unit that two-dimensionally scans and irradiates a display surface that is a surface of the display unit on which the phosphors are arrayed with light.

The occurrence of speckle noise can be prevented by adopting a method for irradiating the phosphor with light, the number of light sources can be set to one by adopting a scanning method, and it is possible to eliminate the need to use a spatial light modulator since it is not necessary to generate a projected representation for realizing image display.

### BRIEF DESCRIPTION OF DRAWINGS

FIG. 1 is a diagram illustrating a configuration example of a display device as a first embodiment.

FIG. 2 is a diagram for describing a configuration outline of a display unit in the embodiment.

FIG. 3 is a diagram illustrating an array example of phosphors in the display unit.

FIG. 4 is an explanatory diagram of a width and an arrangement interval of the phosphor.

FIG. 5 is an explanatory diagram of an image display method as the first embodiment.

FIG. 6 is an explanatory diagram of an example in which the entire light spot is superimposed on the phosphor at the time of provisional irradiation.

FIG. 7 is an explanatory diagram of the significance of conditions relating to the width and the arrangement interval of the phosphor.

FIG. 8 is an explanatory diagram of a viewing angle.

FIG. 9 is an explanatory diagram of an effect of improving safety by the image display method as the embodiment.

FIG. 10 is a flowchart illustrating an example of a specific processing procedure to be executed for realizing the image display method as the first embodiment.

FIG. 11 is a diagram illustrating a configuration example of a display device as a second embodiment.

FIG. 12 is a flowchart illustrating an example of a specific processing procedure to be executed to realize an image display method as the second embodiment.

FIG. 13 is an explanatory diagram of a case where a display surface of a display unit is curved.

### MODE FOR CARRYING OUT THE INVENTION

Hereinafter, embodiments according to the present technology will be described in the following order with reference to the accompanying drawings.
<1. First Embodiment>
[1-1. Configuration Example of Display Device]
[1-2. Image Display Method as First Embodiment]
[1-3. Processing Procedure]
<2. Second Embodiment>
<3. Modifications>
<4. Summary of Embodiments>
<5. Present Technology>

### 1. First Embodiment

### 1-1. Configuration Example of Display Device

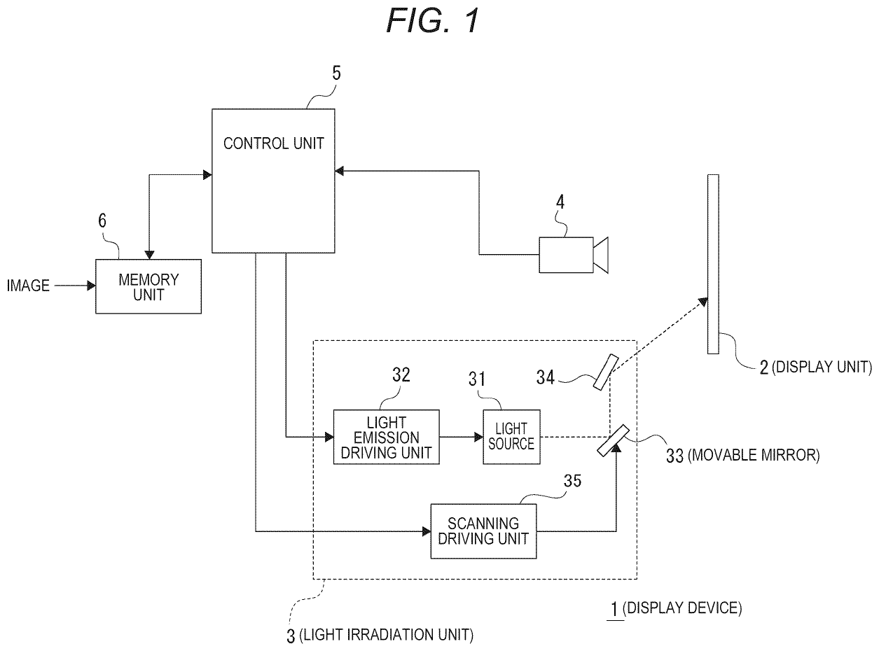

FIG. 1 is a diagram illustrating a configuration example of a display device 1 as a first embodiment according to the present technology.

As illustrated in the drawing, the display device 1 includes a display unit 2, a light irradiation unit 3, a camera unit 4, a control unit 5, and a memory unit 6.

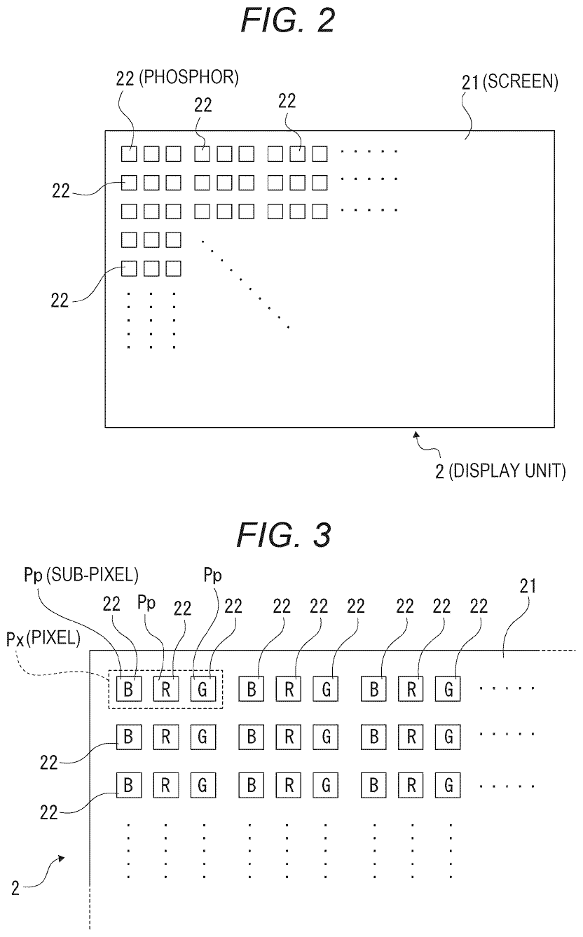

The display unit 2 will be described with reference to FIGS. 2 to 3.

As illustrated in FIG. 2, the display unit 2 has a configuration in which a plurality of phosphors 22 is two-dimensionally arrayed on a screen 21 as a base material.

The screen 21 is formed as a film-shaped body, and contains, for example, a flexible material such as paper or resin.

In this example, the screen 21 is black.

FIG. 3 is an explanatory diagram of an array example of the phosphors 22.

In this example, in order to enable display of a color image, a total of three types of phosphors 22 are used, one that emits B (blue) light, one that emits R (red) light, and one that emits G (green) light.

As described later, in this example, since ultraviolet light is used as excitation light for the phosphor 22, the phosphor 22 that emits the B light (hereinafter referred to as a “B-light phosphor 22”) is configured as a phosphor that emits the B light with respect to incidence of the ultraviolet light, the phosphor 22 that emits the R light (hereinafter referred to as a “R-light phosphor 22”) is configured as a phosphor that emits the R light with respect to incidence of the ultraviolet light, and the phosphor 22 that emits the G light (hereinafter referred to as a “G-light phosphor 22”) is configured as a phosphor that emits G light with respect to incidence of the ultraviolet light.

In the display unit 2, a total of three phosphors 22 including the B-light phosphor 22, the R-light phosphor 22, and the G-light phosphor 22 constitute one unit, and a plurality of units is two-dimensionally arrayed on the screen 21. This unit constitutes one pixel Px in the display unit 2. Accordingly, in the display unit 2, it can be said that a plurality of pixels Px including a total of three phosphors 22 of the B-light phosphor 22, the R-light phosphor 22, and the G-light phosphor 22 is two-dimensionally arrayed on the screen 21.

In each pixel Px, a region where each phosphor 22 is formed is referred to as a sub-pixel Pp as illustrated in the drawing.

In this example, an array order of the phosphors 22 in the pixels Px is an order of the B-light phosphor 22, the R-light phosphor 22, and the G-light phosphor 22 in order from a left side when the display unit 2 is viewed from a front side, but this array order is merely an example, and the array order of the phosphors 22 in the pixels Px can be another order such as, for example, an order of the R-light phosphor 22, the G-light phosphor 22, and the B-light phosphor 22.

In the display unit 2 of this example, a black phosphor is used for each phosphor 22.

That is, the phosphor has a black appearance color.

In this example, the number of pixels (the number of pixels Px) in the display unit 2, that is, a resolution of the display unit 2 is similarly set to full high definition (FHD: horizontal direction x vertical direction=1920×1080) resolution in correspondence with the fact that a resolution of an image to be displayed (hereinafter referred to as a “target image”) is the FHD.

Note that, the resolutions of the target image and the display unit 2 are not limited to the FHD, and for example, other resolutions such as 4 K (3840×2160) and HD (1280×720) can be adopted.

In FIG. 1, the light irradiation unit 3 two-dimensionally scans and irradiates a display surface, which is a surface of the display unit 2 on which the phosphors 22 are arrayed, with light.

As illustrated in the drawing, the light irradiation unit 3 includes a light source 31, a light emission driving unit 32, a movable mirror 33, a mirror 34, and a scanning driving unit 35.

The light source 31 is provided as a light source of the excitation light of the phosphor 22. As an example, a semiconductor laser is used as the light source 31.

Furthermore, the light source 31 in this example emits invisible light. Specifically, the light source 31 of this example emits ultraviolet light (wavelength λ=10 nm to 380 nm).

The light emission driving unit 32 drives the light source 31 to emit light. The light emission driving unit 32 includes a drive circuit for driving a light-emitting element in the light source 31, and drives the light source 31 to emit light on the basis of an instruction from the control unit 5.

Furthermore, the light emission driving unit 32 has a function of adjusting the amount of light emission of the light source 31 (that is, the amount of light emission of the excitation light). Specifically, the light emission driving unit 32 in this example is configured to be able to adjust the amount of light emission of the light source 31 by a pulse width modulation (PWM) method.

The light emitted from the light source 31 is reflected by a mirror surface of the movable mirror 33, then reflected by the mirror 34, and applied to the display surface of the display unit 2. In this example, a micro electro mechanical systems (MEMS) mirror is used as the movable mirror 33.

The movable mirror 33 is driven by the scanning driving unit 35. The scanning driving unit 35 includes a driving circuit that drives the movable mirror 33, and drives the movable mirror 33 such that the light emitted from the light source 31 is two-dimensionally scanned and emitted on the display surface of the display unit 2. In this case, for example, scanning is performed in a mode in which a plurality of pixels Px (1920×1080 in this example) formed in the display unit 2 is irradiated with light in raster order. That is, scanning from a left side to a right side is sequentially performed for every horizontal line from an uppermost horizontal line (pixel row) to a lowermost horizontal line.

Here, in the display device 1, it is assumed that a positional relationship between each phosphor 22 arranged on the display unit 2 and the light irradiation unit 3 is known.

Thus, a method for driving the movable mirror 33 (that is, a “driving method”) in order to realize the light scanning with respect to each phosphor 22 described above is known.

The scanning driving unit 35 is configured to drive the movable mirror 33 according to such a known driving method.

Note that, here, although an example in which the MEMS mirror is used as the movable mirror 33 has been described, another type of movable mirror such as a galvanometer mirror may be used as the movable mirror 33.

Furthermore, here, although an example in which the mirror 34 is used has been described, it is not essential to provide the mirror 34.

The camera unit 4 includes a solid-state imaging element such as a complementary metal oxide semiconductor (CMOS) image sensor or a charge coupled device (CCD) image sensor, for example, and images the display surface of the display unit 2. A position, an orientation, an angle of view, and the like of the camera unit 4 are set such that the entire region (that is image display region) in which the phosphors 22 are arrayed in the display unit 2 falls within an imaging visual field.

The control unit 5 includes, for example, a microcomputer including a central processing unit (CPU), a read only memory (ROM), and a random access memory (RAM), and performs overall control of the display device 1.

Specifically, the control unit 5 controls the amount of light emission of the light source 31 by controlling the light emission driving unit 32, and controls start or stop of an optical scanning operation by the movable mirror 33 by controlling the scanning driving unit 35.

Furthermore, the control unit 5 controls the memory unit 6.

The memory unit 6 includes, for example, a nonvolatile memory such as a flash memory or a volatile memory, and stores information according to an instruction from the control unit 5. In this example, the memory unit 6 is used as a memory for storing the image to be the target image described above. Specifically, in this example, in order to display an image as a moving image, each frame image in the moving image is input as the target image. The memory unit 6 sequentially stores frame images in the moving image according to an instruction from the control unit 5.

In this example, since the target image is a color image, the frame image described above includes an R image, a G image, and a B image.

The control unit 5 performs control such that the light irradiation unit 3 irradiates every phosphor 22 arrayed in the display unit 2 with light of the amount of light emission corresponding to a pixel value (luminance value) of a corresponding pixel in the target image.

With this control, an image based on the target image can be displayed on the display unit 2.

Here, specific processing to be performed by the control unit 5 for realizing image display will be described again later.

### 1-2. Image Display Method as First Embodiment

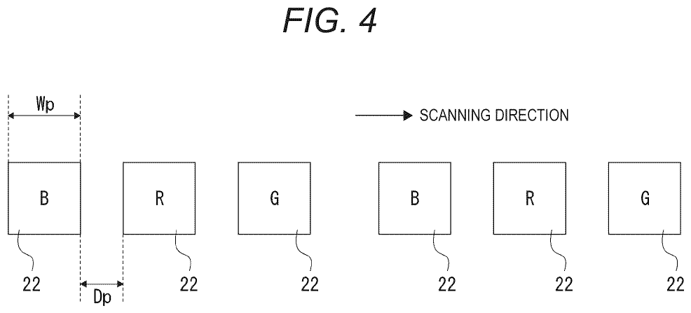

Hereinafter, an image display method as a first embodiment will be described with reference to FIGS. 4 to 6.

First, in order to realize the image display method as the embodiment, the following conditions are imposed on a width and an arrangement interval of the phosphor 22.

FIG. 4 is an explanatory diagram of a width Wp of the phosphor 22 and an arrangement interval Dp of the phosphor 22 in a light scanning direction.

In the present embodiment, the width Wp is twice or more a spot diameter of the light irradiated by the light irradiation unit 3 (spot diameter on the display surface: the “diameter” here means the diameter). Furthermore, a condition in which the arrangement interval Dp is equal to or more than the spot diameter is imposed.

Here, in the present specification, the arrangement interval Dp is a width of a non-formation region of the phosphor 22 between the phosphors 22 arrayed in the scanning direction as illustrated in the drawing.

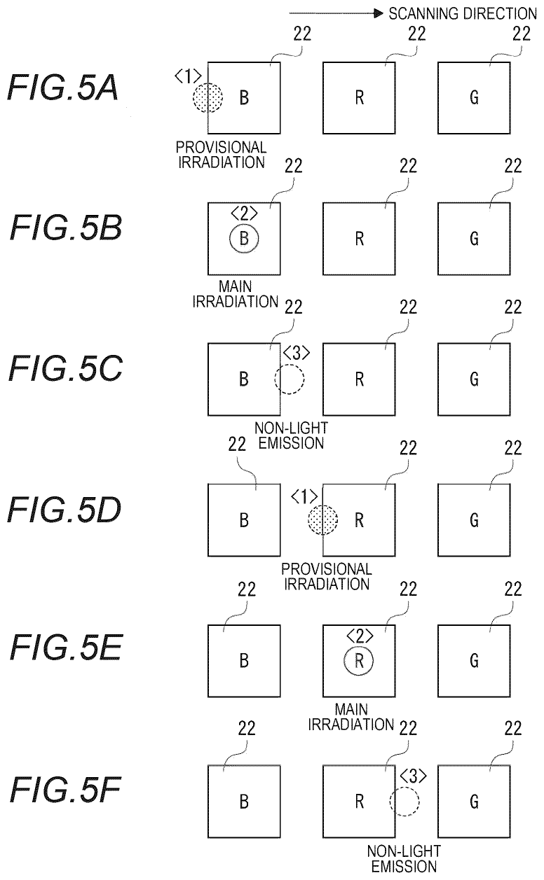

FIG. 5 is an explanatory diagram of the image display method as the first embodiment.

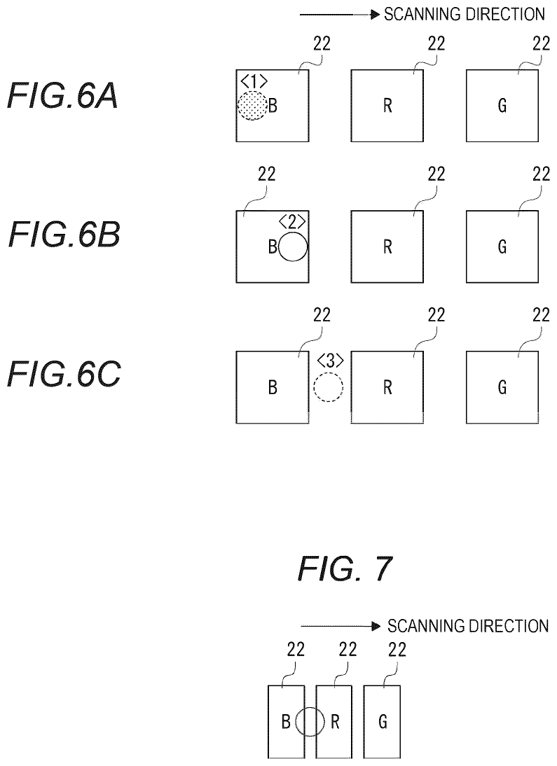

Here, in FIG. 5, a right direction of a paper surface is the light scanning direction by the light irradiation unit 3. The same applies to FIGS. 6 and 7 to be described below.

In this example, since moving image display is assumed, an image display operation is performed for every frame image. That is, an image display operation by a method to be described below is repeated for every frame image (in this example, there are three types of R image, G image, and B image per frame) to be displayed.

First, in the image display, the scanning driving unit 35 of the light irradiation unit 3 starts the driving of the movable mirror 33 for optical scanning described above. That is, in this example, the optical scanning is performed in raster order.

Then, after the driving of the movable mirror 33 for optical scanning is started in this manner, the light source 31 is caused to emit light with a predetermined amount of light emission EL or less. The predetermined amount of light emission EL mentioned here is determined as an amount of light emission at which light emitted from the phosphor 22 in a case where the phosphor 22 is irradiated is not visually recognized by human eyes. For example, it is conceivable to determine the predetermined amount of light emission EL by performing an experiment as to whether or not the predetermined amount of light emission EL is actually visually recognized by human eyes. Alternatively, it is also conceivable to determine the predetermined amount of light emission by simulation.

Hereinafter, performing light irradiation with the amount of light emission by the light source 31 set to be equal to or less than the predetermined amount of light emission EL is referred to as “provisional irradiation”.

In the present embodiment, the provisional irradiation described above is performed to determine the presence or absence of the phosphor 22. In the display device 1 of this example, the camera unit 4 is provided to determine whether or not the phosphor 22 emits light in accordance with the provisional irradiation.

In this example, a frame rate (imaging cycle) of the camera unit 4 is set to be one frame period=time in which scanning light travels a distance corresponding to the spot diameter (that is, time obtained by “spot diameter/moving speed of scanning light”).

FIG. 5A illustrates a scene in a case where the provisional irradiation is performed in accordance with the start of the driving of the movable mirror 33. Specifically, here, a case where the provisional irradiation is performed on a left side of the B-light phosphor 22 as indicated by <1> in the drawing and the state is imaged by the camera unit 4 is illustrated.

In this state, since a part of a light spot caused by the provisional irradiation is present on the B-light phosphor 22, the light emission of the phosphor 22 is detected in the imaged image of the camera unit 4. That is, it can be confirmed that the phosphor 22 is present at a provisionally irradiated position.

In the present embodiment, the control unit 5 performs determination processing of determining whether or not the light emission by the phosphor 22 is detected by the camera unit 4 as a result of performing the provisional irradiation described above in a state where the light irradiation unit 3 is executing the scanning operation, and controls the amount of light emission of irradiation light to an amount of light emission corresponding to a corresponding pixel value in the target image in accordance with the determination that light emission by the phosphor 22 is detected by the determination processing.

Hereinafter, performing light irradiation by controlling the amount of light emission to the amount of light emission corresponding to the pixel value in the target image as described above is referred to as “main irradiation”.

FIG. 5B illustrates an example of a scene in which the main irradiation performed in accordance with the determination that the light emission by the phosphor 22 is detected as a result of the provisional irradiation in FIG. 5A (see <2> in the drawing).

In this example, a processing cycle of processing related to the image display by the control unit 5 is synchronized with a frame cycle of the camera unit 4. Accordingly, in a case where it is detected that the phosphor 22 emits light by the provisional irradiation, the main irradiation is performed in a frame period next to a frame period in which it is detected that the phosphor 22 emits light.

Here, hereinafter, a frame period of the camera unit 4 is referred to as an “imaging frame period” to be distinguished from a frame period of the target image.

As described with reference to FIG. 4, the width Wp of the phosphor 22 is set to twice or more the spot diameter of the irradiation light, and the arrangement interval Dp of the phosphor 22 is set to the spot diameter or more. As a result, it is guaranteed that the main irradiation performed in accordance with the detection of the light emission of the phosphor 22 by the provisional irradiation is performed in a state where the entire light spot falls within a region of the target phosphor 22 as illustrated in the drawing.

Here, regarding the irradiation light by the light irradiation unit 3, a current light irradiation position on the display surface can be estimated from drive information (that is, scanning drive information) of the movable mirror 33, specifically, an elapsed time from a start timing of one two-dimensional scanning, a drive signal of the movable mirror 33, and the like.

Alternatively, the current irradiation position can be estimated on the basis of the imaged image of the camera unit 4 (since a correspondence relationship between a pixel in the imaged image and a position of the phosphor 22 on the display surface becomes known) when a positional relationship between the camera unit 4 and each phosphor 22 arrayed in the display unit 2 is known.

Accordingly, in a case where the light emission of the phosphor 22 by the provisional irradiation is detected as described above, the control unit 5 estimates the current light irradiation position on the display surface on the basis of the drive information of the movable mirror 33 or the imaged image by the camera unit 4, and specifies the pixel value (including pixel values of B, R, and G) of the corresponding pixel in the target image on the basis of the estimated light irradiation position. Then, the main irradiation is executed by causing the light source 31 to emit light with the amount of light emission corresponding to the specified pixel values.

Furthermore, in a case where it is determined that the light emission by the phosphor 22 is not detected as a result of the provisional irradiation, the control unit 5 does not execute the main irradiation but executes the provisional irradiation again in a next imaging frame period.

Therefore, it is possible to prevent the main irradiation from being erroneously performed on a region where the phosphor 22 is not present.

In this case, in accordance with performing the provisional irradiation, the control unit 5 determines whether or not the light emission of the phosphor 22 is detected on the basis of the imaged image of the camera unit 4, and executes the main irradiation in a case where it is determined that the light emission of the phosphor 22 is detected, and executes the provisional irradiation again in a case where it is determined that the light emission of the phosphor 22 is not detected (that is, the provisional irradiation is executed until the light emission of the phosphor 22 is detected).

In a case where the main irradiation is executed, the control unit 5 controls the light source 31 not to emit light as illustrated in FIG. 5C (see <3> in the drawing). That is, in this example, the light source 31 is controlled not to emit light in a next imaging frame period to an imaging frame period in which the main irradiation is executed.

When next provisional irradiation is performed immediately after the main irradiation corresponding to the pixel value is performed, the provisional irradiation is performed again on the phosphor 22 on which the main irradiation is performed, and the same phosphor 22 is doubly detected. As a result, the main irradiation is performed at a wrong position, and the image display cannot be appropriately performed. When a section in which the irradiation light is not emitted is provided between the main irradiation and the provisional irradiation as described above, it is possible to prevent the same phosphor 22 from being doubly detected, to perform the main irradiation at an appropriate position, and to realize appropriate image display.

Furthermore, when the provisional irradiation is performed on the phosphor 22 on which the main irradiation is performed again, a pixel value at a pixel position of the phosphor 22 cannot be appropriately reproduced, but when a section in which the irradiation light is not emitted is provided between the main irradiation and the provisional irradiation as described above, it is possible to prevent the provisional irradiation to be performed on the phosphor 22 on which the main irradiation is performed again, and it is possible to prevent a decrease in reproducibility of the pixel value. That is, in this respect, the appropriate image display can also be realized.

The control unit 5 executes the provisional irradiation again (see <1> in FIG. 5D) in the next imaging frame period to the imaging frame period in which the light source 31 is controlled not to emit light, and determines whether or not the light emission by the phosphor 22 is detected on the basis of the imaged image of the camera unit 4.

In a case where it is determined that the light emission by the phosphor 22 is detected, the main irradiation is executed (see <2> in FIG. 5E). In this case as well, the main irradiation is executed as the light irradiation with the amount of light emission corresponding to the pixel value of the corresponding pixel in the target image on the basis of the result of estimating the current light irradiation position.

Furthermore, in a case where it is determined that the light emission by the phosphor 22 is not detected, the provisional irradiation is executed again (that is, the provisional irradiation is executed until the light emission from phosphor 22 is detected).

In a case where the main irradiation illustrated in FIG. 5E is performed, the control unit 5 controls the light source 31 not to emit light in the next imaging frame period (see <3> in FIG. 5F).

In the image display method as the present embodiment, for each phosphor 22 arrayed in the display unit 2, the provisional irradiation, the determination as to whether or not the light emission of the phosphor 22 by the provisional irradiation is detected, the main irradiation in a case where it is determined that the light emission of the phosphor 22 is detected, and the non-light emission control after the main irradiation described above are performed.

Therefore, image display for reproducing the target image can be realized.

For confirmation, in the present embodiment, a scanning cycle (scanning speed) of the irradiation light is determined to be a sufficiently fast cycle in consideration of a visual integration effect.

Here, in the example of FIG. 5, a case where only a part of the light spot is superimposed on the phosphor 22 at the time of the provisional irradiation is illustrated. However, as illustrated in FIG. 6A, the whole light spot may be superimposed on the phosphor 22 at the time of the provisional irradiation.

As described above, in the present embodiment, since the width Wp of the phosphor 22 is twice or more of the spot diameter, even in a case where the entire light spot is superimposed on the phosphor 22 at the time of the provisional irradiation as described above, it is guaranteed that the main irradiation is performed in a state where the entire light spot falls within the region of the target phosphor 22 as illustrated in FIG. 6B.

Note that, in FIG. 6C, a light spot position corresponding to a non-irradiation time after the main irradiation in this case is illustrated (see <3> in FIG. 6C).

FIG. 7 is an explanatory diagram illustrating the significance of setting the width Wp of the phosphor 22 to twice or more the spot diameter of the irradiation light and setting the arrangement interval Dp to the spot diameter or more. Specifically, FIG. 7 illustrates an array example of the phosphor 22 in a case where the width Wp is less than twice the spot diameter of the irradiation light and the arrangement interval Dp is less than the spot diameter, and also illustrates a relationship between sizes of the spot diameters of the phosphor 22 and the irradiation light.

In this case, it cannot be guaranteed that the main irradiation is performed in a state where the entire light spot falls within the region of the target phosphor 22, and there is a possibility that the light irradiation is performed at a position straddling two adjacent phosphors 22 as illustrated in the drawing. In this case, crosstalk between pixels (crosstalk between sub-pixels Pp in this example: that is, color mixture) occurs.

According to the condition setting of the width Wp and the arrangement interval Dp as the embodiment described with reference to FIG. 4, the occurrence of such crosstalk can also be prevented.

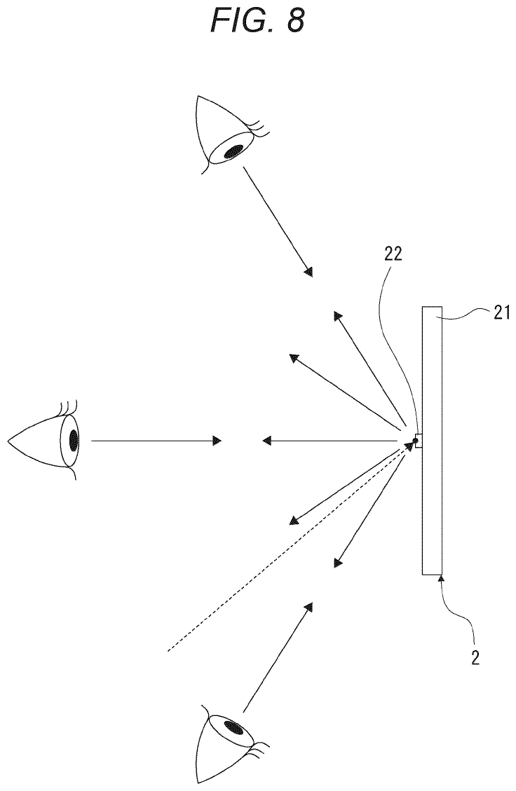

FIG. 8 is an explanatory diagram of a viewing angle.

As illustrated in the drawing, since the phosphor 22 emits diffused light in accordance with the irradiation of the excitation light, it is possible to obtain good viewing angle characteristics by adopting the image display method for causing the phosphor 22 to emit light as in the present embodiment.

In the present embodiment, as described above, a screen 21 is black, and a black phosphor is also used as the phosphor 22.

Therefore, black reproducibility and contrast can be improved.

Here, in the present embodiment, a method for performing the main irradiation in a case where it is determined that the light emission of the phosphor 22 is detected by performing the provisional irradiation is adopted. However, such a method for performing the provisional irradiation is adopted, and thus, safety can be improved.

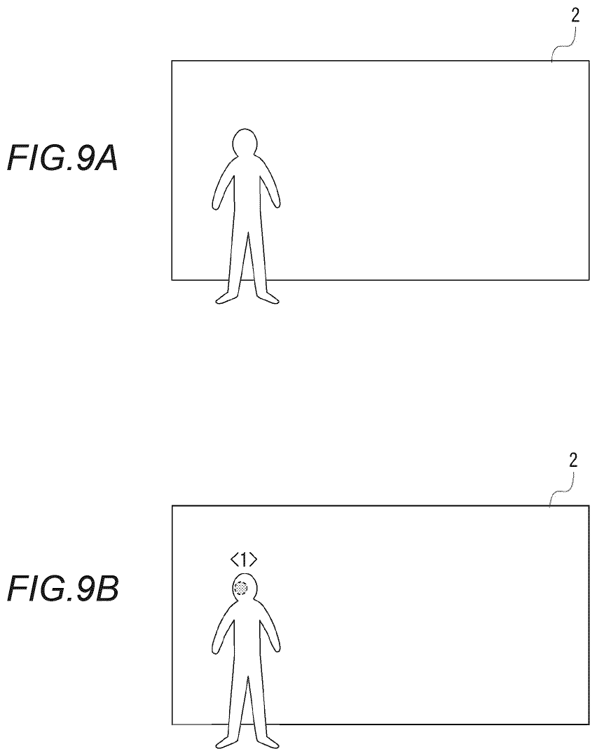

FIG. 9 is an explanatory diagram of this point.

As illustrated in FIG. 9A, it is assumed that a person is present in front of the display unit 2.

In such a case, when the method for performing the provisional irradiation is adopted as in the present embodiment, even though the provisional irradiation is performed for the person as illustrated in FIG. 9B, since the light emission from the phosphor 22 is not detected for the provisional irradiation, the main irradiation is not performed.

Accordingly, it is possible to prevent the light irradiation with a relatively large amount of light emission as the main irradiation for the person, and it is possible to improve safety.

### 1-3. Processing Procedure

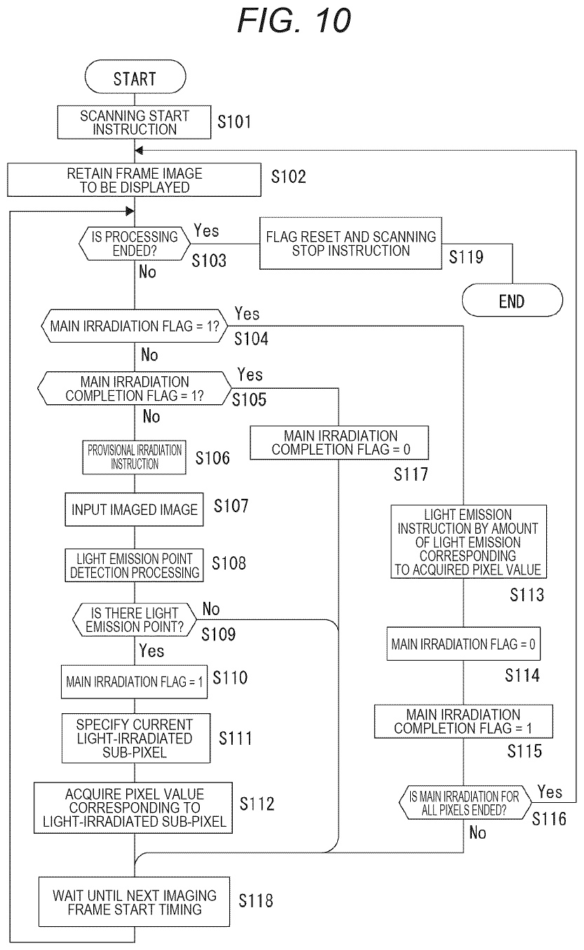

Next, an example of a specific processing procedure to be executed by the control unit 5 to realize the image display method as the first embodiment described above will be described with reference to a flowchart of FIG. 10.

First, in step S101, the control unit 5 issues a scanning start instruction. That is, the scanning driving unit 35 gives an instruction to start the driving of the movable mirror 33.

In step S102 subsequent to step S101, the control unit 5 performs processing for retaining frame images to be displayed. That is, for a target image as a moving image, processing of storing the frame images to be displayed in the memory unit 6 is performed. In this example, since there are three types of frame images to be displayed, that is, a B image, an R image, and a G image, these three types of frame images are stored in the memory unit 6.

The processing in step S102 is executed for every start of image display for one frame. Accordingly, as the frame images to be displayed, a frame image on a most past side in time series (for example, a frame image having a smallest frame number) among undisplayed frame images in the moving image as the target image is stored in the memory unit 6.

In step S103 subsequent to step S102, the control unit 5 determines whether or not the processing is ended. That is, for example, it is determined whether or not a predetermined processing end condition determined in advance to end the series of processing illustrated in FIG. 10, such as an instruction to stop the image display or a power off of the display device, has been satisfied.

In a case where it is determined in step S103 that the processing end condition described above is not satisfied and the processing is not ended, the control unit 5 advances the processing to step S104.

In step S104, the control unit 5 determines whether or not a main irradiation flag=1.

The main irradiation flag is an identifier for identifying whether or not it is a timing at which the main irradiation is to be performed, and “1” indicates that it is a timing at which the main irradiation is to be performed, and “0” indicates that it is not a timing at which the main irradiation is to be performed.

In a case where it is determined in step S104 that the main irradiation flag is not 1, the control unit 5 proceeds to step S105 and determines whether or not the main irradiation completion flag is 1. A main irradiation completion flag is an identifier for identifying whether or not the main irradiation is performed, and “1” indicates that the main irradiation is performed, and “0” indicates that the main irradiation is not performed.

In a case where it is determined in step S105 that the main irradiation completion flag is not 1, the control unit 5 proceeds to step S106 and gives a provisional irradiation instruction.

That is, an instruction is issued to the light emission driving unit 32 such that the light source 31 emits light with the amount of light emission equal to or less than the predetermined amount of light emission EL described above.

In step S107 subsequent to step S106, the control unit 5 inputs the imaged image. That is, the image imaged by the camera unit 4 is input.

Then, in subsequent step S108, the control unit 5 executes light emission point detection processing. That is, processing of detecting a light emission point by the phosphor 22 is performed by image analysis processing on the input imaged image.

In step S109 subsequent to step S108, the control unit 5 determines whether or not the light emission point is detected. That is, it is determined whether or not the light emission point by the phosphor 22 is detected by the detection processing in step S108.

In a case where it is determined in step S109 that the light emission point is detected, the control unit 5 proceeds to step S110, sets the main irradiation flag to “1”, and then performs processing of specifying a current light-irradiated sub-pixel in step S111. That is, as described above, processing of specifying a current light irradiation position, specifically, a light-irradiated sub-pixel as the sub-pixel Pp (phosphor 22) irradiated with light is performed on the basis of the drive information of the movable mirror 33 or the imaged image of the camera unit 4.

In step S112 subsequent to step S111, the control unit 5 performs processing of acquiring a pixel value corresponding to the light-irradiated sub-pixel. That is, for example, when the specified light-irradiated sub-pixel is the B-light phosphor 22 in an n-th pixel Px, a pixel value at a corresponding pixel position in a frame image of a color corresponding to the specified light-irradiated sub-pixel among the B image, the R image, and the G image retained in the memory unit 6 is acquired such that the pixel value of the corresponding pixel in the frame image as the B image retained in the memory unit 6 is acquired.

In accordance with the execution of the processing in step S112, the control unit 5 advances the processing to step S118, performs processing of waiting until a next imaging frame start timing, and then returns to step S103.

When the processing is not ended in step S103, the processing proceeds to step S104.

At this time, as described above, when the light emission of the phosphor 22 by the provisional irradiation is detected and the main irradiation flag=1 is set in step S110, the processing proceeds from step S104 to step S113.

In step S113, the control unit 5 issues a light emission instruction by the amount of light emission corresponding to the acquired pixel value. That is, the light emission instruction by the amount of light emission corresponding to the pixel value acquired in step S112 is issued to the light emission driving unit 32.

Therefore, in a case where the light emission of the phosphor 22 by the provisional irradiation is detected in an immediately preceding imaging frame period, the main irradiation by the amount of light emission corresponding to the pixel value corresponding to the phosphor 22 is performed on the phosphor 22 in which the light emission is detected in a current imaging frame period.

In step S114 subsequent to step S113, the control unit 5 resets the main irradiation flag to “0”, and further sets the main irradiation completion flag to “1” in subsequent step S115.

The main irradiation flag is set to “0” in step S114, and thus, it is possible to prevent the main irradiation from being continuously performed in the next imaging frame period. Furthermore, the main irradiation completion flag is set to “1” in step S115, and thus, it is possible to set the light source 31 not to emit light without performing the provisional irradiation in the imaging frame period immediately after the main irradiation (details will be described below).

In step S116 subsequent to step S115, the control unit 5 determines whether or not the main irradiation for all the pixels is ended. That is, it is determined whether or not the main irradiation is performed for all the pixels of the frame image retained in the memory unit 6 in step S102.

In a case where it is determined in step S116 that the main irradiation for all the pixels is not ended, the control unit 5 advances the processing to step S118 described above, waits until the next imaging frame start timing, and then returns to step S103.

In the imaging frame period immediately after the main irradiation, since the main irradiation flag=0 (see step S114) and the main irradiation completion flag=1 (see step S115), the processing proceeds to step S104→step S105→step S117 unless the processing is ended in step S103.

In step S117, the control unit 5 resets the main irradiation completion flag to “0”. Then, the processing proceeds to step S118 described above.

Therefore, in the imaging frame period immediately after the main irradiation, the light source 31 is in a non-light emission state, and the above-described non-light emission section after the main irradiation is realized.

Furthermore, in a case where the control unit 5 determines that the light emission point is not detected in step S109, the processing proceeds to step S118.

Therefore, in the imaging frame period immediately after it is determined that the light emission point is not detected, when the processing is not ended in step S103, the processing proceeds to step S104→step S105→step S106, and the provisional irradiation is performed and the light emission of the phosphor 22 by the provisional irradiation is determined again.

In a case where it is determined in step S116 that the main irradiation for all the pixels is ended, the control unit 5 returns to step S102. Therefore, the processing for the image display described as the processing of steps S104 to S118 is performed for the next frame image.

In a case where it is determined in step S103 that the processing is ended, the control unit 5 ends the series of processing illustrated in FIG. 10 after performing flag reset and scanning stop instruction processing in step S119, that is, the processing of resetting the main irradiation flag and the main irradiation completion flag to 0, and issuing the instruction to stop the driving of the movable mirror 33 to the scanning driving unit 35.

### 2. Second Embodiment

Next, a second embodiment will be described.

In the second embodiment, the amount of light emission of the main irradiation is adjusted in consideration of the amount of light emission of the phosphor 22 that emits light accompanying the provisional irradiation.

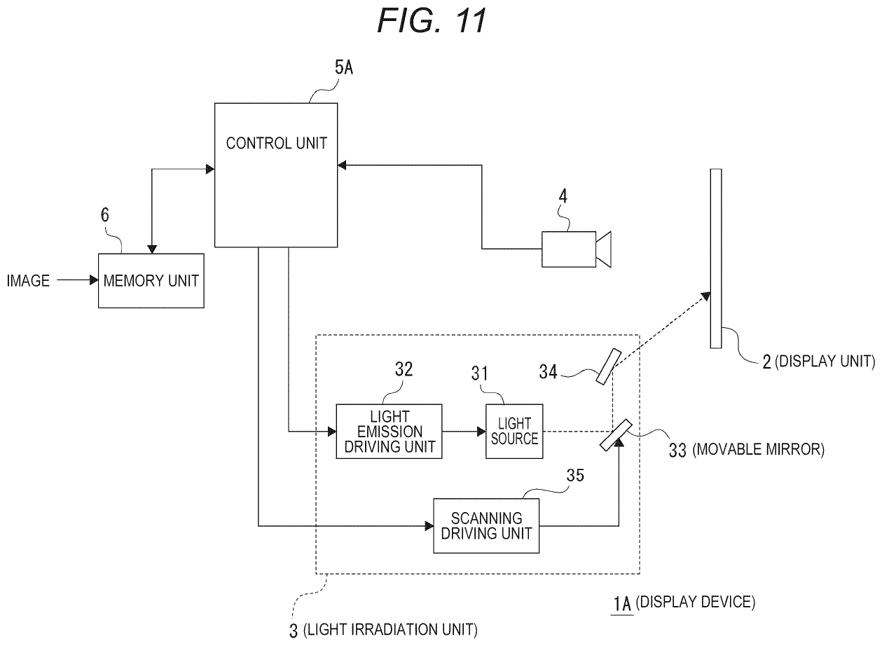

FIG. 11 is a diagram illustrating a configuration example of a display device 1A as the second embodiment.

Note that, in the following description, portions similar to the portions already described will be denoted by the same reference signs, and explanation thereof will be omitted.

The display device 1A is different from the display device 1 as the first embodiment in that a control unit 5A is provided instead of the control unit 5.

In a case where it is determined that the light emission by the phosphor 22 is detected as a result of the provisional irradiation, the control unit 5A controls the amount of light emission of the main irradiation to the amount of light emission based on the amount of light emission of the irradiation light at the time of the provisional irradiation and the pixel value.

Specifically, the control unit 5A controls the amount of light emission of the main irradiation to the amount of light emission that cancels the amount of light emission of the phosphor 22 at the time of the provisional irradiation. More specifically, the main irradiation is executed by the amount of light emission obtained by subtracting the amount of light emission of the light source 31 at the time of the provisional irradiation from the amount of light emission of the light source 31 indicated by the pixel value.

Therefore, it is possible to prevent the decrease in the reproducibility of the pixel value due to the provisional irradiation, and it is possible to improve the image reproducibility.

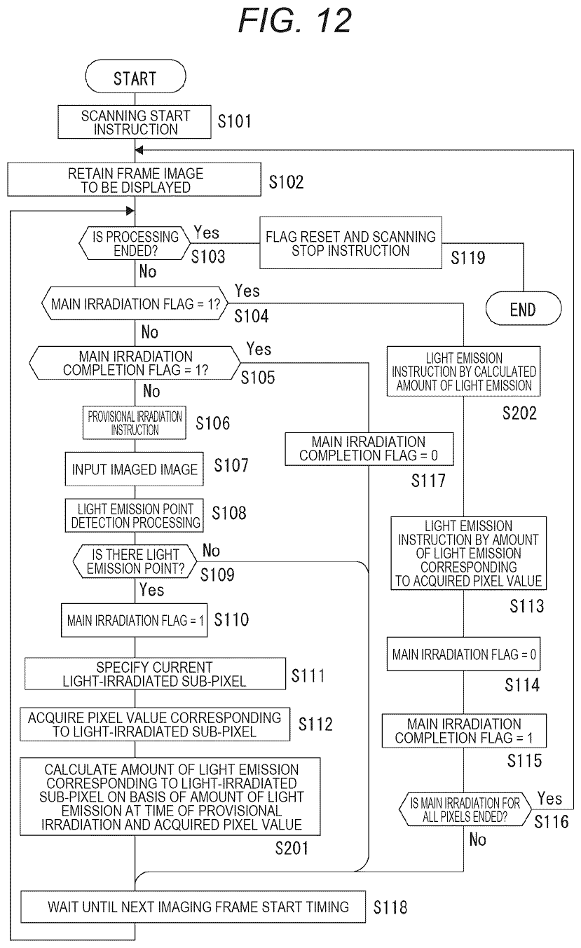

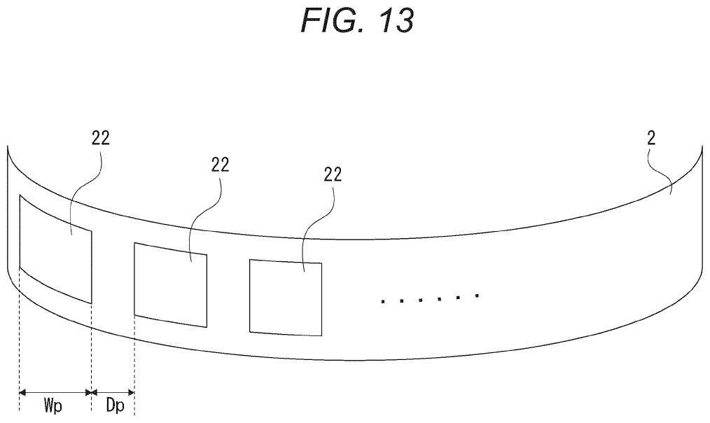

FIG. 12 is a flowchart illustrating an example of a specific processing procedure to be executed by the control unit 5A to realize an image display method as the second embodiment described above.

A difference from the processing illustrated in FIG. 10 is that processing of steps S201 and S202 is added.

In accordance with the execution of the processing of step S112, the control unit 5A advances the processing to step S201, and performs processing of calculating the amount of light emission corresponding to the light-irradiated sub-pixel on the basis of the amount of light emission at the time of the provisional irradiation and the acquired pixel value. Specifically, the amount of light emission based on the amount of light emission of the light source 31 at the time of the provisional irradiation executed in step S106 and the amount of light emission of the light source 31 indicated by the pixel value acquired in step S112 is calculated. More specifically, the amount of light emission of the light source 31 at the time of the provisional irradiation is subtracted from the amount of light emission of the light source 31 indicated by the pixel value.

In accordance with the execution of the calculation processing in step S201, the control unit 5A advances the processing to step S118, waits until the next imaging frame start timing, and returns to step S103.

Thus, in the imaging frame period immediately after the calculation processing in step S201 is executed, when the processing is not ended in step S103, the processing proceeds to step S103→step S104→step S202.

In step S202, the control unit 5A issues a light emission instruction by the calculated amount of light emission. That is, the instruction to cause the light source 31 to emit light by the amount of light emission calculated in step S201 is issued to the light emission driving unit 32.

Therefore, the main irradiation in this case is performed such that the amount of light emission of the phosphor 22 at the time of the provisional irradiation is canceled.

The control unit 5A advances the processing to step S114 in accordance with the execution of the processing of step S202. Therefore, also in the second embodiment, the light source 31 is caused not to emit light in the imaging frame period immediately after the main irradiation is performed, and then the provisional irradiation is performed again in the next imaging frame period.

### 3. Modifications

Although various embodiments according to the present technology have been described above, the present technology is not limited to the specific examples described above, and configurations as various modifications can be adopted.

For example, in the description described above, a case where the base material on which the phosphor 22 is arrayed is formed as the film-shaped body such as the screen 21 has been illustrated, but the base material is not limited to the film-shaped body, and may take other forms such as a plate shape, a corner shape, and a spherical shape.

Here, as illustrated in FIG. 13, it is assumed that the display surface of the display unit 2 is curved.

In this case, in order to establish the image display method as the embodiment described above, it is sufficient if the conditions described above with reference to FIG. 4 are satisfied for the width Wp and the arrangement interval Dp in the state of facing the display unit 2.

Note that, in a case where there is a step on the display surface of the display unit 2 or the like, it can be said that the phosphors 22 are strictly arrayed three-dimensionally, but in a case where the display surface is viewed from the front, it can be considered that the phosphors 22 are “two-dimensionally” arrayed. Accordingly, in the present specification, even in such a case, the phosphors 22 are treated as being “two-dimensionally” arrayed.

Furthermore, in the description described above, an example in which the semiconductor laser is used as the light source 31 has been described. However, for example, a light-emitting element other than the semiconductor laser, such as a light-emitting diode (LED), can also be used as the light source 31.

Furthermore, in the description described above, an example in which ultraviolet light is used as the irradiation light (excitation light) for the phosphor 22 has been described, but it is also conceivable to use, for example, invisible light other than ultraviolet light, such as infrared light, for the irradiation light.

Moreover, the irradiation light is not limited to the invisible light, and it is also conceivable to use visible light such as blue-violet light (wavelength λ=about 380 nm to 400 nm), for example.

Note that, in a case where the infrared light is used as the irradiation light, it is conceivable to use, for example, a vertical cavity surface emitting laser (VCSEL) as the light source 31.

Furthermore, in the description described above, an example in which the amount of light emission of the irradiation light with respect to the phosphor 22 is adjusted by the PWM method has been described, but a configuration in which the amount of light emission is adjusted by a current value control method can also be adopted.

Furthermore, in the description described above, the scanning of the irradiation light is performed in the raster order, but a mode of scanning is not limited to the raster order, for example, a mode of reciprocating scanning, that is, a mode of reversing the scanning direction for every horizontal line is adopted.

Furthermore, in the description described above, the configuration corresponding to the display of the color image has been illustrated, but the image display method according to the present technology can also be suitably applied to a case where a monochrome image is displayed. In this case, as the phosphor 22, the phosphors 22 having the same emission color are arrayed instead of arraying a plurality of types having different emission colors. In this case, the number of phosphors 22 is only required to be at least the same as the number of pixels of the target image.

Furthermore, in the description described above, the camera unit 4 is used to determine whether or not the phosphor 22 emits light by the provisional irradiation. However, in determining whether or not the phosphor 22 emits light by the provisional irradiation, it is sufficient if at least a light receiving unit capable of receiving light generated on the display surface of the display unit 2 is provided, and it is not essential to use the camera unit 4.

Furthermore, in the description described above, a case where the base material on which the phosphor 22 is arrayed is black has been illustrated, but it is also conceivable that the base material is not black but has transparency. In that case, when a background of the base material is black, a black reproducibility improving effect and a contrast improving effect can be similarly obtained.

Furthermore, it is also conceivable to configure the phosphor 22 not to be black but to have transparency. In that case, when the background of the phosphor 22 is black, the black reproducibility improving effect and the contrast improving effect can be similarly obtained.

### 4. Summary of Embodiments

As described above, the display device (1 or 1A) as the embodiment includes the display unit (2) on which the plurality of phosphors (22) is two-dimensionally arrayed on the base material (screen 21), and the light irradiation unit (3) that two-dimensionally scans and irradiates the display surface, which is the surface of the display unit on which the phosphors are arrayed, with light.

The occurrence of speckle noise can be prevented by adopting a method for irradiating the phosphor with light, and the number of light sources can be set to one by adopting a scanning method, and it is also possible to eliminate the need to use a spatial light modulator since it is not necessary to generate a projected representation for realizing image display.

Accordingly, it is possible to reduce device manufacturing cost by reducing the number of components of the display device while preventing the occurrence of speckle noise.

Furthermore, in the display device as the embodiment, the phosphors corresponding to at least the number of pixels of the target image which is a display target image are arrayed on the display unit, and the control unit (5 or 5A) that performs control such that the light irradiation unit emits light by the amount of light emission corresponding to the pixel value of the corresponding pixel in the target image is provided for every phosphor.

Therefore, an image in which a degree of light or darkness for every pixel in the target image is appropriately reproduced can be obtained as the display image by the display unit.

Moreover, the display device as the embodiment includes the light receiving unit (camera unit 4) that receives light generated on the display surface of the display unit. The control unit performs determination processing of determining whether or not the light emission by the phosphor is detected by the light receiving unit in a state where the amount of light emission of the irradiation light by the light irradiation unit is controlled to a predetermined amount of light emission or less in a state where the light irradiation unit is executing the scanning operation, controls the amount of light emission of the irradiation light to the amount of light emission corresponding to the pixel value in accordance with the determination that the light emission by the phosphor is detected by the determination processing, and does not control the amount of light emission of the irradiation light to the amount of light emission corresponding to the pixel value in a case where it is determined that the light emission by the phosphor is not detected by the determination processing.

According to the configuration described above, during the scanning operation of the light irradiation unit, whether or not there is the phosphor at the current light irradiation position is estimated by the light irradiation having the predetermined amount of light emission or less, that is, the light irradiation as so-called provisional irradiation. Then, in a case where it is estimated that there is the phosphor, the light irradiation of the amount of light emission corresponding to the pixel value, that is, the light irradiation as so-called main irradiation is performed, and in a case where it is estimated that there is no phosphor, the light irradiation as the main irradiation is not performed.

The method for performing the main irradiation corresponding to the pixel value on the basis of the result of estimating whether or not there is the phosphor by performing the provisional irradiation as described above is adopted, and thus, it is possible to reduce the amount of light emission of the irradiation light in a case where there is no phosphor. As a result, it is possible to reduce power consumption in realizing the image display.

Furthermore, according to the method described above, in a case where the person is present in front of the display unit, the light emission by the phosphor is not detected by the light receiving unit. Accordingly, the main irradiation is not performed on the person, and thus, safety can be improved.

Moreover, in the display device as the embodiment, in the display unit, the width of the phosphor in the scanning direction of the light by the light irradiation unit is twice or more the spot diameter of the light emitted by the light irradiation unit, and the arrangement interval of the phosphor in the scanning direction is equal to or more than the spot diameter.

Therefore, in a case where the method for performing the main irradiation on the basis of the result of estimating the presence or absence of the phosphor by the provisional irradiation is adopted, it is possible to guarantee that the main irradiation is performed in a state where the entire spot of the irradiation light falls within the region of the phosphor, and it is possible to prevent the occurrence of the crosstalk between the pixels.

Furthermore, in the display device as the embodiment, the control unit performs specification processing of specifying the phosphor that emits light with respect to the irradiation light having the predetermined amount of light emission or less on the basis of the imaged image obtained by imaging the display surface or the scanning drive information in the light irradiation unit, and controls the amount of light emission corresponding to the pixel value of the pixel corresponding to the phosphor specified by the specification processing among the pixels of the target image as the control of the amount of light emission of the irradiation light corresponding to the determination that the light emission by the phosphor is detected by the determination processing.

Therefore, the image display for appropriately reproducing the target image can be realized.

Moreover, in the display device as the embodiment, in a case where the control unit controls the amount of light emission of the irradiation light to the amount of light emission corresponding to the pixel value in accordance with the result of the determination processing, the control unit performs control such that the irradiation light is not emitted and then controls the amount of light emission of the irradiation light to be equal to or less than the predetermined amount of light emission again.

When the next provisional irradiation is performed immediately after the main irradiation corresponding to the pixel value is performed, the provisional irradiation is performed again on the phosphor on which the main irradiation is performed, and the same phosphor is doubly detected. As a result, the main irradiation is performed at a wrong position, and the image display cannot be appropriately performed. When the section in which the irradiation light is not emitted is provided between the main irradiation and the provisional irradiation as described above, it is possible to prevent the same phosphor from being doubly detected, to perform the main irradiation at an appropriate position, and to realize appropriate image display. Furthermore, when the provisional irradiation is performed on the phosphor on which the main irradiation is performed again, the pixel value at the pixel position of the phosphor cannot be appropriately reproduced, but when the section in which the irradiation light is not emitted is provided between the main irradiation and the provisional irradiation as described above, it is possible to prevent the provisional irradiation from being performed on the phosphor on which the main irradiation is performed again, and it is possible to prevent the decrease in the reproducibility of the pixel value. That is, in this respect, the appropriate image display can also be realized.

Moreover, in the display device as the embodiment, when the light irradiation by the light irradiation unit performed by controlling the amount of light emission to be equal to or less than the predetermined amount of light emission is set as the provisional irradiation, in a case where it is determined that the light emission by the phosphor is detected by the determination processing, the control unit (5A) controls the amount of light emission of the irradiation light to the amount of light emission based on the amount of light emission of the irradiation light at the time of the provisional irradiation and the pixel value.

Therefore, the main irradiation can be performed such that the amount of light emission of the phosphor at the time of the provisional irradiation is canceled.

Accordingly, it is possible to prevent the decrease in the reproducibility of the pixel value due to the provisional irradiation, and it is possible to improve the image reproducibility.

Furthermore, in the display device as the embodiment, in the display unit, the plurality of sets of the plurality of types of phosphors having different emission colors is two-dimensionally arrayed on the base material.

Therefore, the color image can be displayed.

Moreover, in the display device as the embodiment, the light irradiation unit emits invisible light as the irradiation light to the display surface.

Therefore, it is possible to prevent the irradiation light from being visually recognized as noise light by a person viewing the display image on the display unit, and it is possible to improve the visibility of the display image and the display image quality.

Moreover, in the display device as the embodiment, the base material is black or transparent.

The base material is black, and thus, the reproducibility of black can be improved. As a result, contrast can be improved. Furthermore, since the base material has transparency, it is possible to similarly improve the black reproducibility and the contrast in a case where the background of the base material is black.

Furthermore, in the display device as the embodiment, the phosphor has black color or transparency.

The phosphor has black, and thus, the reproducibility of black can be improved. As a result, contrast can be improved. Furthermore, since the phosphor has transparency, it is possible to similarly improve black reproducibility and contrast in a case where the background of the phosphor is black.

Moreover, in the display device as the embodiment, the light irradiation unit is configured to be able to adjust the amount of irradiation light by the PMW method.

The PMW method tends to have a higher reaction speed for light amount adjustment than the current value control method.

Accordingly, image reproducibility can be improved.

Furthermore, the display method as the embodiment is the display method for displaying the image by two-dimensionally scanning and irradiating the display surface, which is the surface on which the plurality of phosphors is arrayed in the display unit on which the plurality of phosphors is two-dimensionally arrayed on the base material, with light.

According to such a display method, it is also possible to obtain actions and effects similar to those of the display device as the embodiment described above.

Note that, the effects described in the present description are merely examples and are not limited, and furthermore, other effects may be provided.

### 5. Present Technology

The present technology can also adopt the following configurations.
(1)
A display device including:
a display unit on which a plurality of phosphors is two-dimensionally arrayed on a base material; and
a light irradiation unit that two-dimensionally scans and irradiates a display surface that is a surface of the display unit on which the phosphors are arrayed with light.
(2)
The display device according to the above (1),
in which the phosphors corresponding to at least the number of pixels of a target image that is a display target image are arrayed on the display unit, and
a control unit that performs control such that the light irradiation unit emits light by an amount of light emission corresponding to a pixel value of a corresponding pixel in the target image is provided for every phosphor.
(3)
The display device according to the above (2), further including:
a light receiving unit that receives light generated on the display surface of the display unit,
in which, in a state where the light irradiation unit is executing a scanning operation, the control unit performs determination processing of determining whether or not light emission by the phosphor is detected by the light receiving unit in a state where an amount of light emission of irradiation light by the light irradiation unit is controlled to a predetermined amount of light emission or less, and controls the amount of light emission of the irradiation light to an amount of light emission corresponding to the pixel value in accordance with the determination that light emission by the phosphor is detected by the determination processing, and does not control the amount of light emission of the irradiation light to an amount of light emission corresponding to the pixel value in a case where it is determined that the light emission by the phosphor is not detected by the determination processing.
(4)
The display device according to the above (3),
in which, in the display unit, a width of the phosphor in a scanning direction of light by the light irradiation unit is set to twice or more a spot diameter of the light emitted by the light irradiation unit, and
an arrangement interval of the phosphor in the scanning direction is set to the spot diameter or more.
(5)
The display device according to the above (4),
in which the control unit performs specification processing of specifying the phosphor that emits light with respect to the irradiation light having the predetermined amount of light emission or less on the basis of an imaged image obtained by imaging the display surface or scanning drive information in the light irradiation unit, and controls an amount of light emission corresponding to a pixel value of a pixel corresponding to the phosphor specified by the specification processing, among pixels of the target image, as the control of the amount of light emission of the irradiation light corresponding to the determination that the light emission by the phosphor is detected by the determination processing.
(6)
The display device according to the above (5), in which, in a case where the amount of light emission of the irradiation light is controlled to the amount of light emission corresponding to the pixel value in accordance with a result of the determination processing, the control unit performs control such that the irradiation light is not emitted, and then controls the amount of light emission of the irradiation light to the predetermined amount of light emission or less again.
(7)
The display device according to any one of the above (3) to (6),
in which, when the light irradiation by the light irradiation unit performed by controlling the amount of light emission to the predetermined amount of light emission or less is provisional irradiation,
the control unit controls the amount of light emission of the irradiation light to the amount of light emission based on the amount of light emission of the irradiation light at the time of the provisional irradiation and the pixel value in a case where it is determined that the light emission by the phosphor is detected by the determination processing.
(8)
The display device according to any one of the above (1) to (7), in which, in the display unit, a plurality of sets of a plurality of types of the phosphors having different emission colors is two-dimensionally arrayed on the base material.
(9)
The display device according to any one of the above (1) to (8), in which the light irradiation unit emits invisible light as irradiation light to the display surface.
(10)
The display device according to any one of the above (1) to (9), in which the base material has black color or transparency.
(11)
The display device according to any one of the above (1) to (10), in which the phosphor has black color or transparency.
(12)
The display device according to any one of the above (1) to (11), in which the light irradiation unit is configured to be able to adjust an amount of irradiation light by a PMW method.
(13)
A display method including:
displaying an image by two-dimensionally scanning and irradiating a display surface, which is a surface on which a plurality of phosphors is arrayed, with light in a display unit on which the phosphors are two-dimensionally arrayed on a base material.

### REFERENCE SIGNS LIST

1, 1A Display device
2 Display unit
21 Screen
22 Phosphor
3 Light irradiation unit
31 Light source
32 Light emission driving unit
33 Movable mirror
34 Mirror
35 Scanning driving unit
4 Camera unit
5, 5A Control unit
6 Memory unit
Px Pixel
Pp Sub-pixel

What is claimed is:

1. A display device, comprising:
a display unit on which a plurality of phosphors is two-dimensionally arrayed on a base material; and
a light irradiation unit that two-dimensionally scans and irradiates a display surface that is a surface of the display unit on which the phosphors are arrayed with light.

2. The display device according to claim 1,
wherein the phosphors corresponding to at least the number of pixels of a target image that is a display target image are arrayed on the display unit, and
a control unit that performs control such that the light irradiation unit emits light by an amount of light emission corresponding to a pixel value of a corresponding pixel in the target image is provided for every phosphor.

3. The display device according to claim 2, further comprising:
a light receiving unit that receives light generated on the display surface of the display unit,
wherein, in a state where the light irradiation unit is executing a scanning operation, the control unit performs determination processing of determining whether or not light emission by the phosphor is detected by the light receiving unit in a state where an amount of light emission of irradiation light by the light irradiation unit is controlled to a predetermined amount of light emission or less, and controls the amount of light emission of the irradiation light to an amount of light emission corresponding to the pixel value in accordance with the determination that light emission by the phosphor is detected by the determination processing, and does not control the amount of light emission of the irradiation light to an amount of light emission corresponding to the pixel value in a case where it is determined that the light emission by the phosphor is not detected by the determination processing.

4. The display device according to claim 3,
wherein, in the display unit, a width of the phosphor in a scanning direction of light by the light irradiation unit is set to twice or more a spot diameter of the light emitted by the light irradiation unit, and
an arrangement interval of the phosphor in the scanning direction is set to the spot diameter or more.

5. The display device according to claim 4,
wherein the control unit performs specification processing of specifying the phosphor that emits light with respect to the irradiation light having the predetermined amount of light emission or less on a basis of an imaged image obtained by imaging the display surface or scanning drive information in the light irradiation unit, and controls an amount of light emission corresponding to a pixel value of a pixel corresponding to the phosphor specified by the specification processing, among pixels of the target image, as the control of the amount of light emission of the irradiation light corresponding to the determination that the light emission by the phosphor is detected by the determination processing.

6. The display device according to claim 5, wherein, in a case where the amount of light emission of the irradiation light is controlled to the amount of light emission corresponding to the pixel value in accordance with a result of the determination processing, the control unit performs control such that the irradiation light is not emitted, and then controls the amount of light emission of the irradiation light to the predetermined amount of light emission or less again.

7. The display device according to claim 3,
wherein, when the light irradiation by the light irradiation unit performed by controlling the amount of light emission to the predetermined amount of light emission or less is provisional irradiation,
the control unit controls the amount of light emission of the irradiation light to the amount of light emission based on the amount of light emission of the irradiation light at the time of the provisional irradiation and the pixel value in a case where it is determined that the light emission by the phosphor is detected by the determination processing.

8. The display device according to claim 1, wherein, in the display unit, a plurality of sets of a plurality of types of the phosphors having different emission colors is two-dimensionally arrayed on the base material.

9. The display device according to claim 1, wherein the light irradiation unit emits invisible light as irradiation light to the display surface.

10. The display device according to claim 1, wherein the base material has black color or transparency.

11. The display device according to claim 1, wherein the phosphor has black color or transparency.

12. The display device according to claim 1, wherein the light irradiation unit is configured to be able to adjust an amount of irradiation light by a PMW method.

13. A display method, comprising:
displaying an image by two-dimensionally scanning and irradiating a display surface, which is a surface on which a plurality of phosphors is arrayed, with light in a display unit on which the phosphors are two-dimensionally arrayed on a base material.
